(19) United States
(12) Patent Application Publication
(10) Pub. No.: US 2013/0151647 A1
(43) Pub. Date: Jun. 13, 2013

(54) METHOD FOR REWRITING PROGRAM, REPROGRAM APPARATUS, AND ELECTRONIC CONTROL UNIT

(71) Applicant: DENSO CORPORATION, Kariya-city (JP)

(72) Inventor: Takuya TATSUMI, Obu-city (JP)

(73) Assignee: DENSO CORPORATION, Kariya-city (JP)

(21) Appl. No.: 13/693,186

(22) Filed: Dec. 4, 2012

(30) Foreign Application Priority Data
Dec. 9, 2011 (JP) 2011-269933

(51) Int. Cl. G06F 15/167

(52) U.S. Cl. CPC G06F 15/167
USPC 709/213

(57) ABSTRACT

A reprogram apparatus does not transmit a reprogram data set as it is. The reprogram data set has a plurality of unit blocks and is used for rewriting a program in a memory of a subject electronic control unit (ECU). A consecutive range having at least the predetermined number of consecutive specified unit blocks is extracted. Range size information indicating a range size of the extracted consecutive range is transmitted to the subject ECU. The reprogram data set excluding the specified unit blocks included in the consecutive range is transmitted to the subject ECU on a unit-block-by-unit-block basis. The subject ECU restores the data corresponding to the consecutive range containing the specified unit blocks, which are not received from the reprogram apparatus, based on the range size information received. The reprogram data set is thereby restored. Rewriting of the program is executed using the reprogram data set restored.

### CROSS REFERENCE TO RELATED APPLICATION

The present application is based on Japanese Patent Application No. 2011-269933 filed on Dec. 9, 2011, the disclosure of which is incorporated herein by reference.

1. Technical Field

The present disclosure relates to a method for rewriting a program in an electronic control unit, a reprogram apparatus, and an electronic control unit the program of which is rewritten.

2. Background

Patent document 1: JP 2001-034601 A

Patent document 2: JP 2009-227247 A (US 20090248912 A)

To eliminate a defect in a vehicle or customize the vehicle, a program in an electronic control unit (ECU) connected to an in-vehicle communication system is rewritten using as a tool a reprogram apparatus linked to the in-vehicle communication system.

The ECU contains a rewritable nonvolatile memory to store the program such as a flash memory having a storage capacity of several megabytes. In contrast, the in-vehicle communication system includes well-known CAN (Controller Area Network), the transmission speed of which is about 500 k bps. The data volume of a single communication frame of CAN is eight (8) bytes.

This causes a reprogram work to need much time in transmitting reprogram data, providing a disadvantage in working efficiency. Patent document 1 describes a technique of shortening the transmission time by compressing the reprogram data.

In such a technique, a subject ECU the program of which is rewritten receives the reprogram data compressed and decompresses it using a decompression program, thereby writing the reprogram data decompressed in a memory such as a flash memory.

Further, the above technique needs time in compressing and decompressing the reprogram data, providing a disadvantage not to enhance the working efficiency sufficiently. Further, the technique needs to previously install a decompression program to decompress the reprogram data in the subject ECU or to transfer the reprogram data to decompress before reprogramming. The former case provides a disadvantage to need to store the decompression program in a limited data area of the memory; the latter case provides a disadvantage to reduce working efficiency.

### SUMMARY

It is an object of the present disclosure to reduce work time to reprogram by reducing data volume of a reprogram data to reprogram an electronic control unit without need of a compression program or a decompression program.

To achieve the above object, according to a first example of the present disclosure, a method is provided for rewriting a program stored in a memory in a subject unit using a reprogram apparatus via an in-vehicle communication system linked with the reprogram apparatus. The subject unit is one of a plurality of electronic control units included in the in-vehicle communication system. The method includes the following: (a) dividing, in the reprogram apparatus, a reprogram data set, which is used for rewriting the program, into a plurality of unit blocks, each unit block having a predetermined data length and a serial number; (b) designating, in the reprogram apparatus, specified unit blocks each having a prespecified value; (c) designating, in the reprogram apparatus, a consecutive range containing at least a predetermined minimum number of said specified unit blocks; (d) transmitting, from the reprogram apparatus to the subject unit, range information containing a range start number and a range end number, the range start number being the serial number assigned to the specified unit block being a start of the consecutive range, the range end number being the serial number assigned to the specified unit block being an end of the consecutive range; (e) transmitting, from the reprogram apparatus to the subject unit, transmit-target blocks that are the unit blocks of the plurality of unit blocks other than the specified unit blocks included in the consecutive range; and (f) restoring, in the subject unit, the reprogram data set using (i) the specified unit blocks included in the consecutive range generated based on the range information and (ii) the transmit-target blocks that are transmitted from the reprogram apparatus, rewriting the program in the memory.

This configuration enables the reduction in the data volume of the reprogram data set transmitted via the in-vehicle communication system without using an existing compression program or decompression program. As a result, the time necessary for the data communication decreases, raising the working efficiency in reprogramming.

The memory storing a program in the electronic control unit may be composed of multiple sectors, each of which has a predetermined data size, and be reprogrammed on a sector-by-sector basis. In such a case, an unused portion of the sector may have the data “0 (zero),” therefore reducing the data volume effectively.

According to a second example of the present disclosure, a reprogram apparatus linked with an in-vehicle communication system is provided as follows. The reprogram apparatus rewrites a program stored in a memory in a subject unit via the in-vehicle communication system. The subject unit is one of a plurality of electronic control units included in the in-vehicle communication system. The reprogram apparatus includes a division section, a consecutive range designation section, a specified unit block designation section, a consecutive range designation section, a range information transmission section, and a block data transmission section. The division section divides a reprogram data set, which is used for rewriting the program, into a plurality of unit blocks, each unit block having a predetermined data length and a serial number. The specified unit block designation section designates specified blocks each having a prespecified value. The consecutive range designation section designates a consecutive range containing at least a predetermined minimum number of said specified unit blocks. The range information transmission section transmits range information containing a range start number and a range end number to the subject unit, the range start number being the serial number assigned to the unit block being a start of the consecutive range, the range end number being the serial number assigned to the unit block being an end of the consecutive range. The block data transmission section transmits transmit-target blocks to the subject unit, the transmit-target blocks being the unit blocks of the plurality of unit blocks other than the specified unit blocks included in the consecutive range.

According to a third example of the present disclosure, an electronic control unit in an in-vehicle communication system is provided as follows. The in-vehicle communication system is linked with a reprogram apparatus. The electronic control unit contains a reprogrammable memory that stores a program. The reprogram apparatus executes part of the method of the first example. Such part of the method contains (a) dividing the reprogram data set, (b) designating the specified unit blocks, (c) designating the consecutive range, (d) transmitting the range information, and (e) transmitting the transmit-target blocks. The electronic control unit includes a range information reception section, a block data reception section, and a rewrite section. The range information reception section receives the range information containing the range start number and the range end number from the reprogram apparatus via the in-vehicle communication system. The block data reception section receives the transmit-target blocks that are the unit blocks of the plurality of unit blocks other than the specified unit blocks included in the consecutive range. The rewrite section restores the reprogram data set using (i) the specified unit blocks included in the consecutive range generated based on the range information and (ii) the transmit-target blocks that are transmitted from the reprogram apparatus, rewriting the program stored in the memory.

According to a fourth example of the present disclosure, a reprogram apparatus linked with an in-vehicle communication system is provided as follows. The reprogram apparatus rewrites a program stored in a memory in a subject unit via the in-vehicle communication system. The subject unit is one of a plurality of electronic control units included in the in-vehicle communication system. The reprogram apparatus includes the following five means. The first means is means for dividing a reprogram data set, which is used for rewriting the program, into a plurality of unit blocks, each unit block having a predetermined data length and a serial number. The second means is means for designating prespecified unit blocks each having a prespecified value. The third means is means for designating a consecutive range containing at least a predetermined minimum number of said specified unit blocks. The fourth means is means for transmitting range information containing a range start number and a range end number to the subject unit, the range start number being the serial number assigned to the unit block being a start of the consecutive range, the range end number being the serial number assigned to the unit block being an end of the consecutive range. The fifth means is means for transmitting transmit-target blocks to the subject unit, the transmit-target blocks being the unit blocks of the plurality of unit blocks other than the specified unit blocks included in the consecutive range.

According to a fifth example of the present disclosure, an electronic control unit in an in-vehicle communication system is provided as follows. The in-vehicle communication system is linked with a reprogram apparatus. The electronic control unit contains a reprogrammable memory that stores a program. The reprogram apparatus executes part of the method of the first example. Such part of the method contains (a) dividing the reprogram data set, (b) designating the specified unit blocks, (c) designating the consecutive range, (d) transmitting the range information, and (e) transmitting the transmit-target blocks. The electronic control unit includes the following three means. The first means is means for receiving the range information containing the range start number and the range end number from the reprogram apparatus via the in-vehicle communication system. The second means is means for receiving the transmit-target blocks that are the unit blocks of the plurality of unit blocks other than the specified unit blocks included in the consecutive range. The third means is means for restoring the reprogram data set using (i) the specified unit blocks included in the consecutive range generated based on the range information and (ii) the transmit-target blocks that are transmitted from the reprogram apparatus, rewriting the program stored in the memory.

The program apparatus according to the second or fourth example or the electronic control unit according to the third example or fifth example may cooperatively achieve the method for rewriting a program according to the first example.

### BRIEF DESCRIPTION OF THE DRAWINGS

The above and other objects, features, and advantages of the present disclosure will become more apparent from the following detailed description made with reference to the accompanying drawings. In the drawings:

FIG. 1 is a block diagram illustrating a configuration of an in-vehicle communication system and a reprogram apparatus according to an embodiment of the present disclosure;

FIG. 2 is a flowchart diagram illustrating a reprogram process in the reprogram apparatus;

FIG. 3 is a flowchart diagram illustrating a reprogram process in an electronic control unit (ECU);

FIG. 4 is a flowchart diagram illustrating a reprogram data set restoration process;

FIGS. 5A, 5B, 5C are diagrams illustrating data structures of data areas in various communication frames; and

FIG. 6 is a sequence diagram illustrating communication frames communicated between the reprogram apparatus and the electronic control unit.

### DETAILED DESCRIPTION

Hereafter, description will be given to an embodiment of the present disclosure with reference to the drawings.

[Configuration]

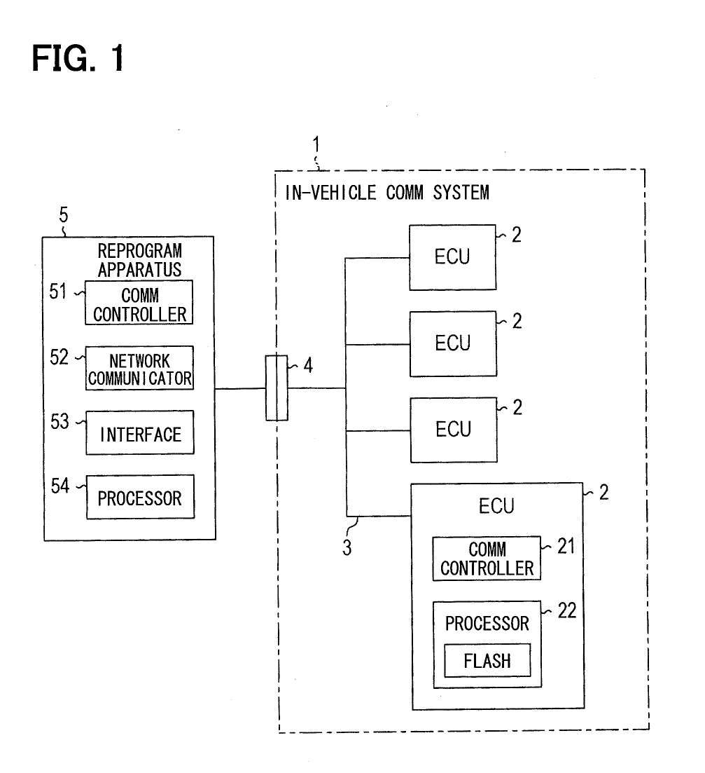

FIG. 1 illustrates a configuration of an in-vehicle communication system 1 and a reprogram apparatus 5 according to an embodiment of the present disclosure.

The in-vehicle communication system 1 includes a plurality of electronic control units (ECUs) 2 in a vehicle; a communication bus 3 to connect the ECUs 2 mutually; and a connector 4 to connect with the reprogram apparatus 5 serving as an external tool to execute diagnosis of vehicular states of the vehicle via the ECUs 2 and rewriting a program of each ECU 2, i.e., reprogramming each ECU 2.

The in-vehicle communication system 1 executes CAN (Controller Area Network) protocols in the communication bus 3. The maximum data volume transmitted by a single communication frame is restricted to N bytes. N is a positive integer; N=8 in the present embodiment.

[ECU]

Each ECU 2 includes a communication controller 21 that executes communication via the communication bus 3, and a processor 22 that is also referred to as an execution unit. The processor 22 acquires or provides a variety of information via the communication controller 21, and executes various processing for realizing a function assigned to the ECU 2 itself based on the acquired information. The processor 22 further executes an ECU-side reprogram process to rewrite a program stored in the ECU 2 itself.

The communication controller 21 has a known configuration to include a CAN transceiver and a CAN controller. The processor 22 includes a known microcomputer to include a CPU (Central Control Unit) and storages. The storages include (i) a flash memory as a rewritable or reprogrammable nonvolatile memory to store a program and (ii) a RAM to temporarily store data. The RAM has a storage data capacity greater than that of the flash memory.

In addition, the flash memory is divided into a plurality of sectors, each of which stores a predetermined data size such as 4 to 64 k bytes. The data or programs in the flash memory are thus erased on a sector-by-sector basis.

[Reprogram Apparatus]

The reprogram apparatus 5 includes a communication controller 51, a network communicator 52, an interface 53, and a processor 54. The communication controller 51 executes communication with the ECUs 2 in the in-vehicle communications system 1 via the connector 4. The network communicator 52 executes communication via a public communication network such as the Internet. The interface 53 is an input and output portion to input a manipulation by a user to the reprogram apparatus 5 or to output (i) information acquired via the communication controller 51 or the network communicator 52 to a user or (ii) manipulation information on procedure to a user. The processor 54 may be also referred to as an execution unit and executes a tool-side or a reprogram-apparatus-side reprogram process which rewrites a program of each ECU 2 according to instructions inputted via the interface 53.

The communication controller 51 is similar to the communication controller 21 of each ECU 2. The network communicator 52 is a known one to include a transceiver or a controller to realize TCP/IP. The processor 54 includes a known microcomputer to include a CPU (Central Control Unit) and a memory.

[Tool-side Reprogram Process]

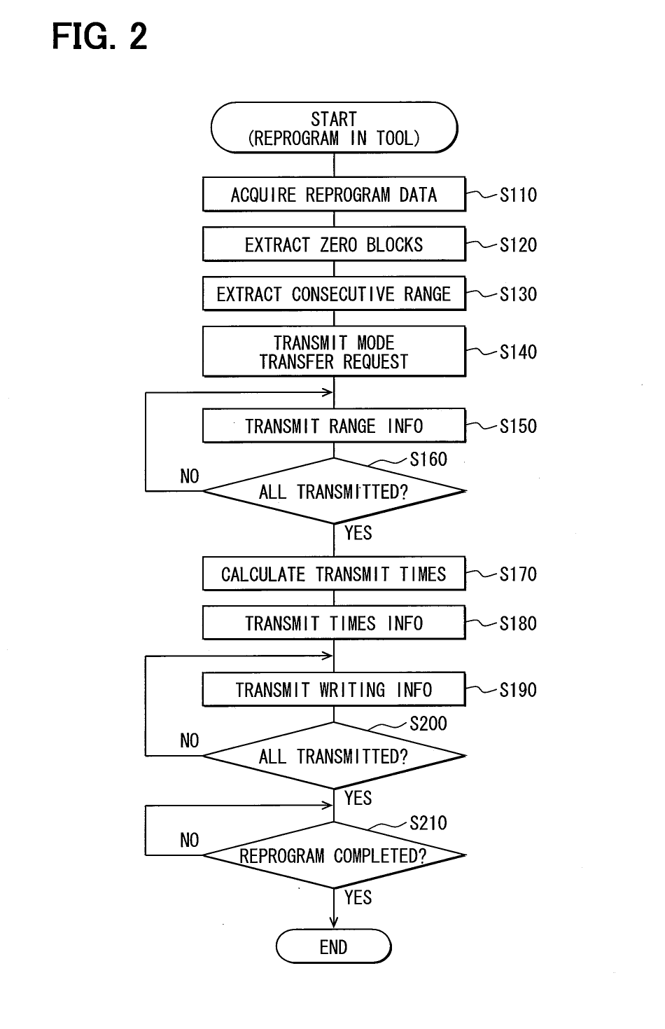

With reference to FIG. 2, the following will explain a tool-side reprogram process executed by the processor 54 of the reprogram apparatus 5. The present process starts when a reprogram instruction that requests an execution of a reprogram process is inputted via the interface 53. The reprogram instruction includes (i) acquisition source information, which indicates a file name and an acquisition source or origin of the reprogram data, and (ii) designation information which designates (a) a target ECU 2 that is a subject ECU of the ECUs 2 as a target for the reprogram process, and target sectors of the flash memory, the target sectors being subject sectors of the multiple sectors as a target for reprogramming.

It is further noted that a flowchart in the present application includes sections (also referred to as steps), which are represented, for instance, as S110. Further, each section can be divided into several sections while several sections can be combined into a single section. Furthermore, each of thus configured sections can be referred to as a module, device, or means and achieved not only (i) as a software section in combination with a hardware unit (e.g., computer), but also (ii) as a hardware section, including or not including a function of a related apparatus. Further, the hardware section may be inside of a microcomputer.

The present process starts. Then, at S110, the processor 54 acquires a reprogram data set via the network communicator 52 based on the acquisition source information indicated in the reprogram instruction. At S120, the acquired reprogram data set is divided into multiple unit blocks. Each unit block is transmitted as one communication frame; each unit block has N bytes. Each unit block is assigned with a corresponding unique serial number. Furthermore, a unit block having all the bits being zero “0” is referred to as a zero unit block that is one example of a specified unit block in the present embodiment. That is, the zero unit block having all the bits being zero may be referred to as a specified unit block indicating a prespecified value. The serial numbers corresponding to the zero unit blocks are extracted.

Next, at S130, the zero unit blocks that are consecutive more than M (M is a predetermined positive integer, for example, M=50) are extracted as a consecutive range. Further at S130, range number information and range size information are generated. The range number information indicates the number of a plurality of consecutive ranges. The range size information is related to each of the plurality of consecutive ranges and includes (i) a range start number being the serial number assigned to the zero unit block being the start unit block in the consecutive range and (ii) a range end number being the serial number assigned to the zero unit block being the end unit block in the consecutive range.

At S140, a reprogram start frame that is a communication frame including a mode transfer request to request a transfer to a reprogram mode is transmitted via the communication controller 51. The reprogram start frame includes the designation information indicated in the reprogram instruction, i.e., the information that designates the target ECU and the target sector(s) for reprogramming.

At S150, the range information frame that is a communication frame indicating the range size information of a single consecutive range is transmitted via the communication controller 51. After transmitting the range information frame, the processor 54 stands by until receiving a response frame from the target ECU, and then advances the processing when receiving the response frame that determines the success in the transmission.

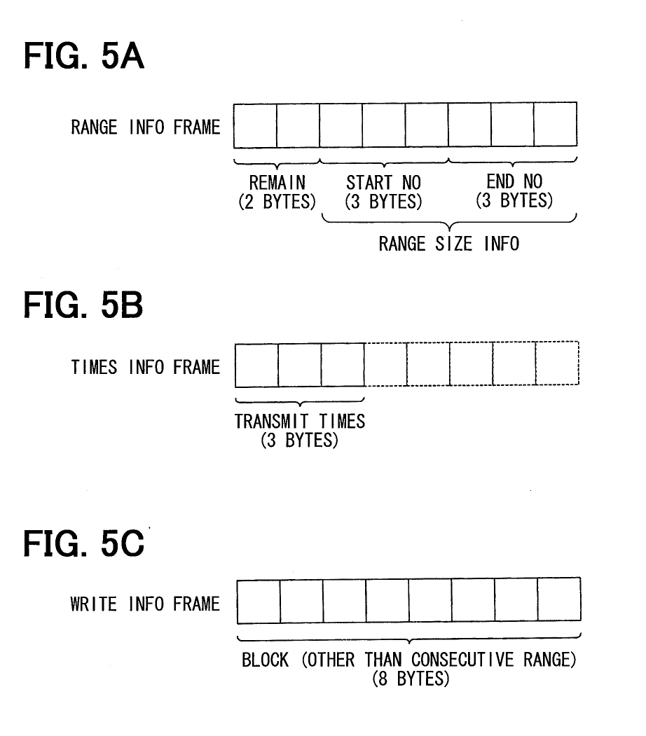

FIG. 5A illustrates the configuration of the data area of the range information frame having 8 bytes. The range information frame contains (i) two bytes of the remaining transmission number of the range information frames and (ii) six bytes of the range size information. The range size information has (i) three bytes of the range start number and (ii) three bytes of the range end number. The remaining transmission number is assigned with a value as follows.

When the first range information frame of the multiple range information frames is transmitted, the value is designated as “[remaining transmission number]<--[range number information]−1.”

Whenever the range information frame is transmitted subsequently, the value is decreased by one to be designated as “[remaining transmission number]<--[remaining transmission number in the previously transmitted range information frame]−1.”

Returning to FIG. 2, at S160, it is determined whether the transmission of all the range information frames corresponding to all the consecutive ranges extracted at S130 is completed. When it is not determined that the transmission is completed, the processing returns to S150, repeatedly transmitting the range information frame.

When it is determined that the transmission is completed, the processing advances to S170. At S170, a necessary transmission times, which may be also referred to as a necessary transmission number of times or a necessary transmission count, is calculated. The necessary transmission times is the total of the transmit-target unit blocks. The transmit-target unit blocks are, of all the unit blocks in the reprogram data set, the unit blocks other than the zero unit blocks included in all the consecutive ranges. At S180, a times information frame that indicates the calculated necessary transmission times is transmitted. After transmitting the times information frame, the processor 54 stands by until receiving a response frame from the target ECU, and then advances the processing when receiving the response frame that determines the success in the transmission.

It is noted that the necessary transmission times is obtained by subtracting the total of the zero unit blocks, which are included in all the multiple consecutive ranges extracted at S130, from the total of the unit blocks included in the reprogram data set obtained at S110.

FIG. 5B illustrates the configuration of the data area of the times information frame. The times information frame uses three bytes of the data area for indicating the necessary transmission times.

At S190, a writing information frame which indicates a value of a single transmit-target unit block is transmitted. After transmitting the writing information frame, the processor 54 stands by until receiving a response frame from the target ECU, and then advances the processing when receiving the response frame that determines the success in the transmission. Whenever transmitting the writing information frame, a transmission counter counting the transmission times is incremented.

At S200, it is determined whether the transmission of all the writing information frames corresponding to all the transmit-target unit blocks by determining whether the value counted by the transmission counter reaches the necessary transmission times. When it is not determined that the value reaches the necessary transmission times, the processing returns to S190, repeatedly transmitting the writing information frame.

In contrast, when it is determined that the value reaches the necessary transmission times, the processing advances to S210. At S210, it is determined whether to receive a reprogram completion frame which indicates the completion of the reprogramming from the target ECU 2. When not receiving the reprogram completion frame, the processing stands by by repeating S210. When receiving the reprogram completion frame, the present process ends.

[ECU-side Reprogram Process]

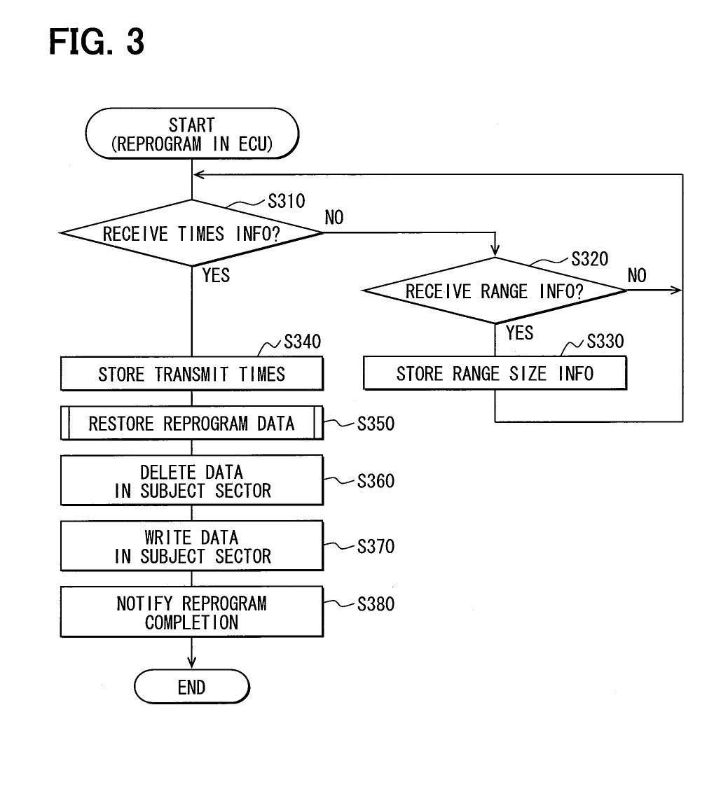

The following will explain an ECU-side reprogram process executed by the processor 22 of the target ECU 2 with reference to FIG. 3. It is noted that the present process starts when the target ECU 2 receives a reprogram start frame containing a mode transfer request destined for the target ECU 2 under a state that the ignition switch is in an on state and the target ECU 2 is thereby in a power-on state.

The present process starts. Then, at S310, the processor 22 determines whether the times information frame is received. When it is not determined that the times information frame is received, the processing advances to S320. At S320, it is determined whether the range information frame is received. When it is not determined that the range information frame is received, the processing returns to S310.

When it is determined that the range information frame is received, the processing advances to S330. At S330, the processor 22 stores the range size information indicated in the range information frame and transmits a response frame. The processing then returns to S310. When it is determined that the times information frame is received, the processing advances to S340. At S340, the processor 22 stores the necessary transmission times indicated in the times information frame and transmits a response frame.

Thereafter, at S350, the processor 22 executes a reprogram data set restoration process to restore the reprogram data set. That is, after subsequently receiving the values indicated in the writing information frames transmitted from the reprogram apparatus 5, the processor 22 restores the reprogram data set based on the values indicated in the writing information frames received, the range size information stored at S330, and the necessary transmission times stored at S340.

At S360, after restoring the reprogram data set by the reprogram data set restoration process, the data in the target sector(s) of the flash memory are deleted based on the designation information indicated in the reprogram start frame received previously. At S370, the processor 22 writes, in the target sector(s), the restored reprogram data set, which is stored in a temporary storage. In other words, the processor 22 rewrites the program in the flash memory of the target ECU 2 using the reprogram data set restored, i.e., reprograms the flash memory of the target ECU 2.

At S380, the processor 22 transmits finally a reprogram completion frame that is a communication frame indicating that the reprogram process is completed, to the reprogram apparatus 5. The present process then ends.

[Reprogram Data Set Restoration]

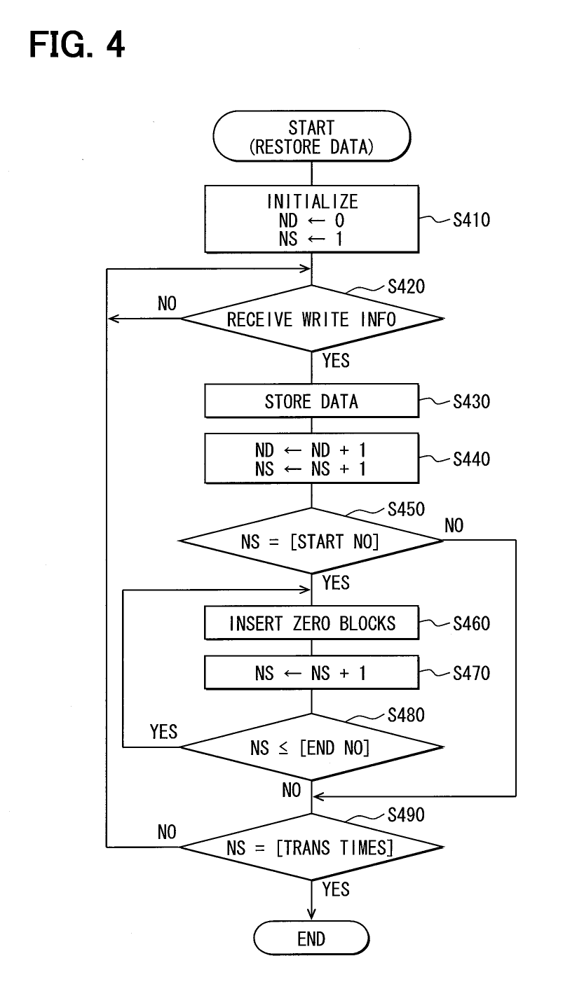

The following will explain a reprogram data set restoration process executed at S350, with reference to FIG. 4.

At S410, the processor 22 initializes parameters used in the present process. In specific, a parameter ND indicating the number of receptions of the writing information frames is set to zero “0”; a parameter NS indicating a serial number of the unit block that is a target for reprogramming is set to one “1.”

At S420, it is determined whether the writing information frame is received. When not receiving the writing information frame, the processing stands by by repeating S420. In contrast, when receiving the writing information frame, the processing advances to S430. At S430, the processor 22 stores the data of a single unit block indicated in the writing information frame in the temporary storage to temporarily store restored reprogram data, and transmits a response frame.

At S440, each of the parameters ND and NS is incremented by one. At S450, it is determined whether the parameter NS accords with the range start number of one of the range size informations stored previously at S330. When the parameter NS accords with the range start number, the processing advances to S460. At S460, the processor 22 executes a zero insertion process that adds data of a single unit block indicating the value being entirely zero “0” to a last end of the restored reprogram data temporarily stored in the temporary storage. At S470, the parameter NS is incremented by one.

At S480, it is determined whether the parameter NS is less than the range end number that is paired with the range start number used at S450. When being less than the range end number, the processing returns to S460, where the zero block insertion is repeatedly executed.

In contrast, when being not less than the range end number at S480, the processing advances to S490. Further, when the parameter NS does not accord with the range start number at S450, the processing also advances to S490. At S490, it is determined whether the parameter ND accords with the necessary transmission times stored at S340.

When the parameter ND does not accord, the processing returns to S420, where the above-mentioned process is repeated. When the parameter ND accords with the necessary transmission times, it is determined that all the writing information frames are completely received. The present process then ends.

That is, the data of the specified unit blocks, i.e., the value of zero “0” of the zero unit blocks, included in each consecutive range are not transmitted from the reprogram apparatus 5. Thus, the data of the specified unit blocks that are omitted from the transmission are inserted based on the range size information, thereby restoring the reprogram data set.

[Operation]

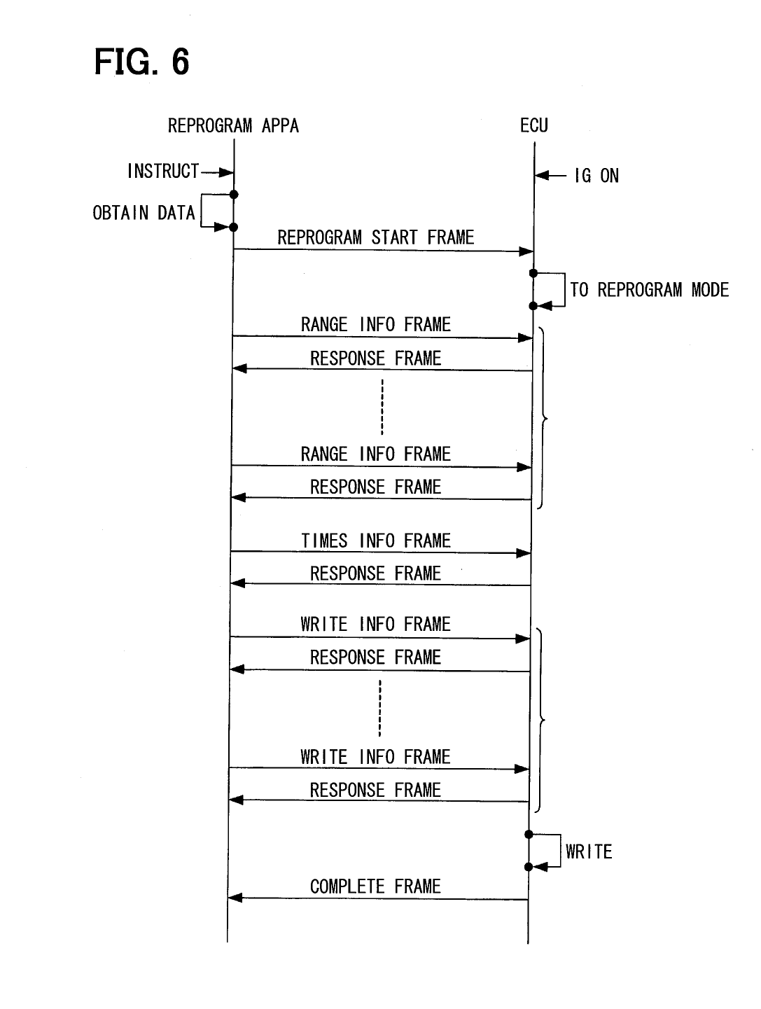

The following will explain a sequence of communication frames communicated between the reprogram apparatus 5 and the target ECU 2 when executing the reprogram process, with reference to FIG. 6.

When a reprogram instruction is manipulated in the reprogram apparatus 5, the reprogram data set is acquired and the reprogram start frame is transmitted to the target ECU 2 which is a subject ECU 2 of the multiple ECUs 2 as a target of the reprogramming.

Then, the target ECU 2 moves an operation mode into the reprogram mode to start the ECU-side reprogram process. Then, the reprogram apparatus 5 repeatedly transmits all the multiple range information frames on a frame-by-frame basis by the number of range information frames. Each range information frame indicates information about a consecutive range that contains consecutive zero unit blocks; the consecutive range contains the consecutive zero unit blocks the number of which is equal to or greater than the predetermined number.

The target ECU 2 repeatedly receives the range information frames and repeatedly returns the response frames, respectively. The reprogram apparatus 5 waits for the reception of the response frame, and then transmits the next range information frame when receiving the response frame. The reprogram apparatus 5 completes the transmission of all the range information frames and then transmits the times information frame that indicates the transmission times, i.e., the number of times the writing information frames will be transmitted. When receiving the response frame to the times information frame, the reprogram apparatus 5 starts the transmission of all the writing information frames. Even when transmitting the writing information frames repeatedly, the reprogram apparatus 5 waits for the response frame to each writing information frame and then transmits the next writing information frame when receiving the response frame responding to the previously transmitted writing information frame.

Finally, the target ECU 2 completes the reception of the writing information frames by the number of transmission times indicated by the times information frame. The target ECU 2 then restores the reprogram data set based on the range size information, the necessary transmission times, and the writing information, all of which are acquired from the reprogram apparatus 5. The target ECU 2 then overwrites or rewrites the data of the target sectors of the flash memory using the restored reprogram data set, and then transmits the program completion frame to the reprogram apparatus 5. The target ECU 2 then moves the operation mode into a usual mode, thereby ending a series of processing.

[Effect]

As explained in the above embodiment, the reprogram apparatus does not transmit a reprogram data set as it is; the reprogram data set has a plurality of unit blocks and is used for rewriting a program. Instead, the reprogram apparatus 5 extracts each consecutive range having equal to or greater than the predetermined number M of consecutive zero unit blocks. After transmitting the range information, which indicates a range size of each consecutive range extracted, to the target ECU 2, the reprogram apparatus 5 transmits the reprogram data set excluding the zero unit blocks included in the consecutive range(s) to the target ECU 2 on a unit-block-by-unit-block basis. The target ECU 2 restores the data corresponding to the consecutive range(s) containing the zero unit blocks, which are not received from the reprogram apparatus 5, based on the range size information received, thereby restoring the reprogram data set thoroughly. The target ECU 2 then rewrites the program in the flash memory or reprogramming the flash memory using the reprogram data set that is restored in the target ECU 2.

The present embodiment does not use any existing compression program or decompression program. The present embodiment may reduce the data volume that is transmitted via the in-vehicle communication system 1 or the transmission time necessary for transmitting the reprogram data. As a result, the working efficiency of the reprogramming may be raised.

In particular, the ECU 2 includes the flash memory serving as a memory storing a program; the flash memory erases the data on a sector-by-sector basis. An unused portion of the sector is apt to have a large consecutive range; therefore, the data volume may be reduced effectively.

Further, as explained in the above, each section in the flowcharts can be divided into several sections while several sections can be combined into a single section. Several examples will be described as follows. The processor 54 of the reprogram apparatus 5 may function as a division section, device, or means by executing S120 in FIG. 2. The processor 54 may further function as a serial number assignment section, device, or means, by executing S120 in FIG. 2. The processor 54 may yet further function as a specified unit block designation section, device, or means, by executing S120 in FIG. 2. The processor 54 may function as a consecutive range designation section, device, or means by executing S130 in FIG. 2; the consecutive range designation section may be incorporated into the above division section. The processor 54 may function as a range information transmission section, device, or means by executing S150 to S160 in FIG. 2. The processor 54 may further function as a block data transmission section, device, or means by executing S170 to S200 in FIG. 2. The processor 22 of the ECU 2 may function as a range information reception section, device, or means by executing S320 to S330 in FIG. 3. The processor 22 may further function as a block data reception section, device, or means by executing S310, S340, S350 in FIG. 3. The processor 22 may further function as a rewrite section, device, or means, which may be also referred to as a reprogram section, device, or means, by executing S350 to S370 in FIG. 3. The processor 22 may further function as a restoration section, device, or means by executing S350 in FIGS. 3 or S410 to S490 in FIG. 4, wherein the restoration section may be incorporated into the rewrite section.

[Other Embodiments]

Up to this point, the description has been given to an embodiment of the present disclosure. However, the present disclosure is not limited to the above embodiment, and it can be variously embodied without departing from the subject matter of the present disclosure.

Further, in the above embodiment, the restoration or regeneration of the consecutive range and restoration of the reprogram data set are executed in conjunction with or parallel with the reception of the writing information frames. Those may be executed at the time of writing to the flash memory.

In addition, the predetermined consecutive number M of the zero unit blocks is used to determine whether to designate the consecutive range. It may be predetermined to be a value providing a sufficient effect in saving the processing time in consideration of the time necessary for transmitting all the data of the consecutive ranges as the writing information frames, or the time necessary for transmitting the range information frames and restoring the consecutive ranges from the range size informations or the like.

In addition, the above embodiment uses the range containing the consecutive zero unit blocks as a consecutive range. Without need to be limited thereto, the range containing consecutive unit blocks, each of which indicates that all the bits are one “1”, may be designated as a consecutive range containing consecutive specified unit blocks, for instance.

It is noted that while some languages such as English use “information” primarily as being an uncountable noun, Basic Japanese Patent Application, which the present application claims the priority based on, uses a Japanese word equivalent to “information” primarily as being a countable noun from the nature of Japanese language. The present application may therefore use “information” as being a countable noun as well as an uncountable noun. That is, “an information” may read “a piece of information,” “an informational element,” “an informational item,” “an informational record” or the like whereas “a plurality of informations” may read “a plurality of pieces of information,” “a plurality of informational elements,” “a plurality of informational items,” “a plurality of informational records,” or the like.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A method for rewriting a program stored in a memory in a subject unit using a reprogram apparatus via an in-vehicle communication system linked with the reprogram apparatus, the subject unit being one of a plurality of electronic control units included in the in-vehicle communication system,
the method comprising:
dividing, in the reprogram apparatus, a reprogram data set, which is used for rewriting the program, into a plurality of unit blocks, each unit block having a predetermined data length and a serial number;
designating, in the reprogram apparatus, specified unit blocks having a prespecified value;
designating, in the reprogram apparatus, a consecutive range containing at least a predetermined minimum number of said specified unit blocks;
transmitting, from the reprogram apparatus to the subject unit, range information containing a range start number and a range end number, the range start number being the serial number assigned to the specified unit block being a start of the consecutive range, the range end number being the serial number assigned to the specified unit block being an end of the consecutive range;
transmitting, from the reprogram apparatus to the subject unit, transmit-target blocks that are the unit blocks of the plurality of unit blocks other than the specified unit blocks included in the consecutive range; and
restoring, in the subject unit, the reprogram data set using (i) the specified unit blocks included in the consecutive range generated based on the range information and (ii) the transmit-target blocks that are transmitted from the reprogram apparatus, rewriting the program in the memory.

2. A reprogram apparatus linked with an in-vehicle communication system, the reprogram apparatus rewriting a program stored in a memory in a subject unit via the in-vehicle communication system, the subject unit being one of a plurality of electronic control units included in the in-vehicle communication system,
the reprogram apparatus comprising:
a division section that divides a reprogram data set, which is used for rewriting the program, into a plurality of unit blocks, each unit block having a predetermined data length and a serial number;
a specified unit block designation section that designates specified blocks having a prespecified value;
a consecutive range designation section that designates a consecutive range containing at least a predetermined minimum number of said specified unit blocks;
a range information transmission section that transmits range information containing a range start number and a range end number to the subject unit, the range start number being the serial number assigned to the unit block being a start of the consecutive range, the range end number being the serial number assigned to the unit block being an end of the consecutive range; and
a block data transmission section that transmits transmit-target blocks to the subject unit, the transmit-target blocks being the unit blocks of the plurality of unit blocks other than the specified unit blocks included in the consecutive range.

3. An electronic control unit in an in-vehicle communication system linked with a reprogram apparatus, the electronic control unit containing a reprogrammable memory that stores a program,
the reprogram apparatus
dividing a reprogram data set, which is used for rewriting the program, into a plurality of unit blocks, each unit block having a predetermined data length and a serial number,
designating specified unit blocks having a prespecified value,
designating a consecutive range containing at least a predetermined minimum number of said specified unit blocks,
transmitting range information containing a range start number and a range end number to the subject unit, the range start number being the serial number assigned to the specified unit block being a start of the consecutive range, the range end number being the serial number assigned to the specified unit block being an end of the consecutive range, and
transmitting, to the subject unit, transmit-target blocks that are the unit blocks of the plurality of unit blocks other than the specified unit blocks included in the consecutive range,
the electronic control unit comprising:
a range information reception section that receives the range information containing the range start number and the range end number from the reprogram apparatus via the in-vehicle communication system;
a block data reception section that receives the transmit-target blocks that are the unit blocks of the plurality of unit blocks other than the specified unit blocks included in the consecutive range; and
a rewrite section that restores the reprogram data set using (i) the specified unit blocks included in the consecutive range generated based on the range information and (ii) the transmit-target blocks that are transmitted from the reprogram apparatus, rewriting the program stored in the memory.

4. A reprogram apparatus linked with an in-vehicle communication system, the reprogram apparatus rewriting a program stored in a memory in a subject unit via the in-vehicle communication system, the subject unit being one of a plurality of electronic control units included in the in-vehicle communication system,
the reprogram apparatus comprising:
means for dividing a reprogram data set, which is used for rewriting the program, into a plurality of unit blocks, each unit block having a predetermined data length and a serial number;
means for designating prespecified unit blocks having a prespecified value,
means for designating a consecutive range containing at least a predetermined minimum number of said specified unit blocks;
means for transmitting range information containing a range start number and a range end number to the subject unit, the range start number being the serial number assigned to the unit block being a start of the consecutive range, the range end number being the serial number assigned to the unit block being an end of the consecutive range; and
means for transmitting transmit-target blocks to the subject unit, the transmit-target blocks being the unit blocks of the plurality of unit blocks other than the specified unit blocks included in the consecutive range.

5. An electronic control unit in an in-vehicle communication system linked with a reprogram apparatus, the electronic control unit containing a reprogrammable memory that stores a program,
the reprogram apparatus
dividing a reprogram data set, which is used for rewriting the program, into a plurality of unit blocks, each unit block having a predetermined data length and a serial number,
designating specified unit blocks having a prespecified value,
designating a consecutive range containing at least a predetermined minimum number of said specified unit blocks,
transmitting range information containing a range start number and a range end number to the subject unit, the range start number being the serial number assigned to the specified unit block being a start of the consecutive range, the range end number being the serial number assigned to the specified unit block being an end of the consecutive range, and
transmitting, to the subject unit, transmit-target blocks that are the unit blocks of the plurality of unit blocks other than the specified unit blocks included in the consecutive range,
the electronic control unit comprising:
means for receiving the range information containing the range start number and the range end number from the reprogram apparatus via the in-vehicle communication system;
means for receiving the transmit-target blocks that are the unit blocks of the plurality of unit blocks other than the specified unit blocks included in the consecutive range; and
means for restoring the reprogram data set using (i) the specified unit blocks included in the consecutive range generated based on the range information and (ii) the transmit-target blocks that are transmitted from the reprogram apparatus, rewriting the program stored in the memory.
